(19) United States
(12) Patent Application Publication
(10) Pub. No.: US 2017/0061424 A1
(43) Pub. Date: Mar. 2, 2017

(54) AUTHENTICATION SYSTEM USING WEARABLE PRESENCE TO MAINTAIN ACCOUNT AUTHENTICATION

(71) Applicant: BANK OF AMERICA CORPORATION, Charlotte, NC (US)

(72) Inventors: Nathan Dent, Concord, NC (US); Matthew K. Bryant, Gastonia, NC (US); Nicholas Munson, Charlotte, NC (US)

(21) Appl. No.: 14/842,303

(22) Filed: Sep. 1, 2015

(51) Int. Cl. G06Q 20/32; G06Q 20/38

(52) U.S. Cl. CPC G06Q 20/3227; G06Q 20/382

(57) ABSTRACT

The present disclosure describes using wearable presence to maintain account authentication. Embodiments herein disclosed receive an authentication request from a wearable device of a user to initiate a transaction using the wearable device; wherein the wearable device includes one or more sensors configured to gather user data including physiological or movement data, or a combination of both; wherein the authentication request includes a transaction type, a transaction amount, and at least one account to be used via the wearable device for the transaction. Embodiments determine if the user is in possession of the wearable device, based on the user data; and, if so, authenticate the at least one account. Embodiments continuously monitor user data from the wearable device to determine if the user remains in possession of the wearable device; and, if so, maintain authentication to the account, thereby allowing the user to conduct one or more transactions upon authentication.

### FIELD OF THE INVENTION

This disclosure generally relates to using the presence of a wearable device to maintain account authentication.

### BACKGROUND

Most non-cash transactions require a payor to provide identification and authentication information associated with the user's payment vehicle to the merchant to prove that the user is authorized to utilize this payment vehicle. These steps normally include providing a signature, displaying an identification card, reciting a zip code, providing a PIN or passcode, or other time consuming activities. Additionally, some users may not wish to present what can be sensitive information to the merchant in a public setting where the information can be seen or overheard.

### SUMMARY OF THE INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, systems, and computer program products are described herein that provide for using wearable presence to maintain account authentication.

Some embodiments characterize a system that includes a computer apparatus including at least one processor and a memory; and a software module, stored in the memory, including computer readable code executable by the processor. The software module is configured to receive an authentication request from a wearable device of a user to initiate a transaction using the wearable device; wherein the wearable device comprises one or more sensors configured to gather user data comprising physiological or movement data, or a combination of both, wherein the authentication request comprises a transaction type, a transaction amount, and at least one account to be used, via the wearable device, for the transaction. The software module is further configured to determine whether or not the user is in possession of the wearable device, based on the user data; and authenticate the at least one account, if the user is in possession of the wearable device, to enable the transaction via the wearable device. The software module is additionally configured to continuously monitor user data from the wearable device to determine whether or not the user remains in possession of the wearable device; and maintain authentication to the account, based on determination that the user remains in possession of the wearable device, thereby allowing the user to conduct one or more transactions upon authentication.

Some embodiments feature a computer implemented method that includes the step of: receiving an authentication request from a wearable device of a user to initiate a transaction using the wearable device; wherein the wearable device comprises one or more sensors configured to gather user data comprising physiological or movement data, or a combination of both, wherein the authentication request comprises a transaction type, a transaction amount, and at least one account to be used, via the wearable device, for the transaction. The method further includes the steps of: determining whether or not the user is in possession of the wearable device, based on the user data; and authenticating the at least one account, if the user is in possession of the wearable device, to enable the transaction via the wearable device. The method additionally includes the steps of: continuously monitoring user data from the wearable device to determine whether or not the user remains in possession of the wearable device; and maintaining authentication to the account, based on determination that the user remains in possession of the wearable device, thereby allowing the user to conduct one or more transactions upon authentication.

Further embodiments provide a computer program product that includes a non-transitory computer readable medium including computer readable instructions. The computer readable instructions include instructions for receiving an authentication request from a wearable device of a user to initiate a transaction using the wearable device; wherein the wearable device comprises one or more sensors configured to gather user data comprising physiological or movement data, or a combination of both, of the user; wherein the authentication request comprises a transaction type, a transaction amount, and at least one account to be used, via the wearable device, for the transaction. The computer readable instructions further include instructions for determining whether or not the user is in possession of the wearable device, based on the user data; and authenticating the at least one account, if the user is in possession of the wearable device, to enable the transaction via the wearable device. The computer readable instructions additionally include instructions for continuously monitoring user data from the wearable device to determine whether or not the user remains in possession of the wearable device; and maintaining authentication to the account, based on determination that the user remains in possession of the wearable device, thereby allowing the user to conduct one or more transactions upon authentication.

Implementations may include one or more of the following features.

In some implementations, the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

In some implementations, the user data is transmitted to the mobile device or to an online storage site, both accessible to the system.

In some implementations, the authentication request is sent from the mobile device.

In some implementations, the software module is further configured to: determine, via the positioning device, the location of the mobile device of the user; determine, via the secure channel, that the mobile device is paired with the wearable device; and determine that the user is in possession of the wearable device, in response to the determination of the location of the mobile device and that the mobile device is paired with the wearable device.

In some implementations, the software module is further configured to: continuously monitor, via the positioning device, to determine the location of the mobile device of the user; continuously monitor, via the secure channel, to determine that the mobile device remains paired with the wearable device; and continuously monitor that the user remains in possession of the wearable device, in response to the determination of the location of the mobile device and that the mobile device remains paired with the wearable device.

In some implementations, the authentication request comprises the user account information comprising a username, a password, a personal identification number (PIN), an account number, a card number, one or more related accounts, or any combination thereof.

In some implementations, the physiological data comprises heart rate, blood pressure, fingerprints, finger vein and palm vein patterns, temperature, and the like; wherein the movement data comprises body movements, gait, and the like.

In some implementations, the authentication request comprises requests for receiving statements related to an account history, executing a purchase at a point-of-sale of a merchant, processing automated teller machine (ATM) transactions, transferring funds from domestic or international accounts, processing commercial payments related to online bill-pay, peer-to-peer payments, account withdrawals, account deposits, or any combination thereof.

In some implementations, the wearable device comprises a watch, a wristband, an ear-pod, a necklace, a wristlet, an anklet, an earring, a headband, a ring, a belt, eyeglasses, contact lenses, clothing, or the like.

In some implementations, the at least one account comprises a deposit account, a debit account, a savings account, a checking account, an investment account, a money market account, a credit account, or the like.

In some implementations, the authentication is maintained until closed by the user.

In some implementations, the authentication is maintained for a time period set by the system.

Other implementations, features and advantages are in the description, drawings and claims.

### BRIEF DESCRIPTION OF THE DRAWINGS

Having thus described embodiments of the invention in general terms, reference may now be made to the accompanying drawings:

FIG. 1 is a block diagram illustrating a system environment including a system for using wearable presence to maintain account authentication, in accordance with an embodiment of the invention;

FIG. 2 is a flowchart illustrating a general process for using wearable presence to maintain account authentication, in accordance with an embodiment of the present invention; and

FIG. 3 is a flowchart illustrating a general process for determining whether or not the user is in possession of the wearable device, in accordance with one embodiment of the present invention.

### DETAILED DESCRIPTION OF EMBODIMENTS OF THE INVENTION

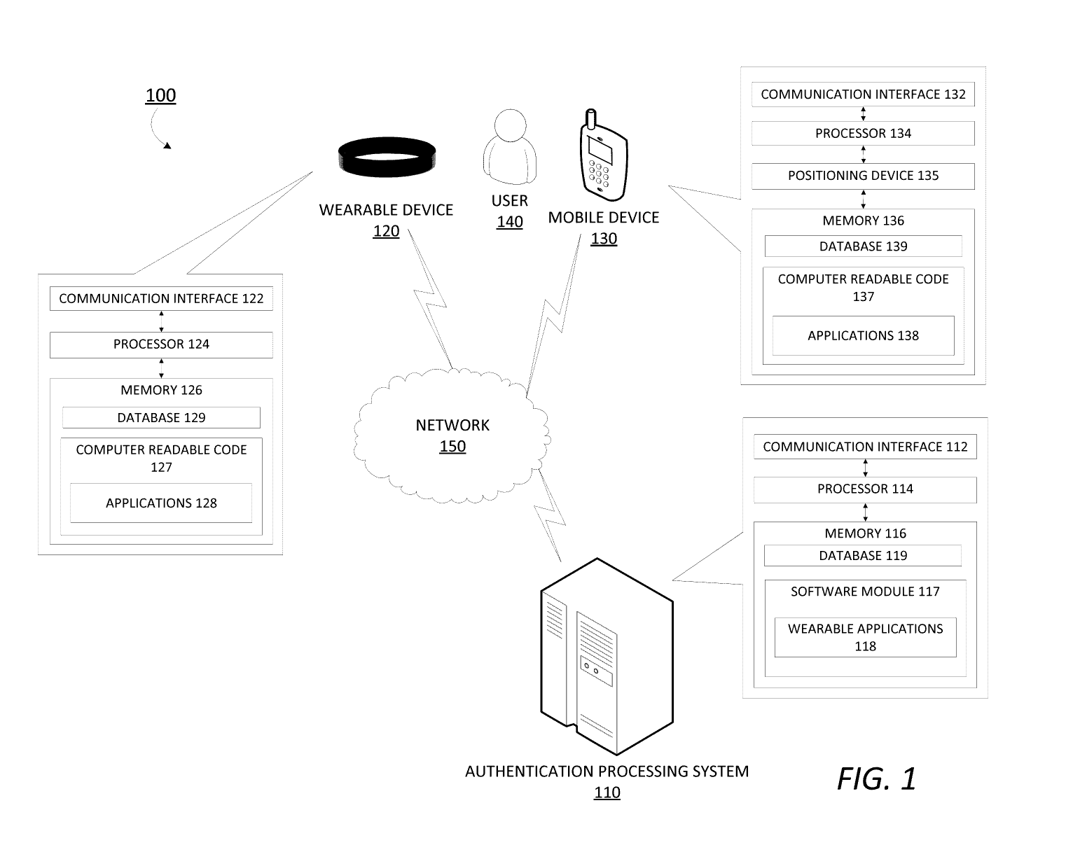

Embodiments of the present invention will now be described with respect to FIGS. 1-3. In the drawings, like reference characters and numbers refer to like elements throughout. Also, the drawings are not necessarily to scale, emphasis instead generally being placed upon illustrating the principles of the invention.

As may be appreciated by one of skill in the art, the present invention may be embodied as a method, system, computer program product, or a combination of the foregoing. Accordingly, the present invention may take the form of an entirely software embodiment (including firmware, resident software, micro-code, and the like) or an embodiment combining software and hardware aspects that may generally be referred to herein as a “system.” Furthermore, embodiments of the present invention may take the form of a computer program product on a computer-readable medium having computer-usable program code embodied in the medium.

In some embodiments, any suitable computer-readable medium may be utilized. In other embodiments, a specialized computer-readable medium may be utilized that is configured for specific functions that encompass more than generic computer functions. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a RAM, a read-only memory (ROM), an erasable programmable read-only memory (EPROM or Flash memory), a compact disc read-only memory (CD-ROM), or other optical or magnetic storage device; or transmission media such as those supporting the Internet, an intranet, or a wireless network. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to one or more processors of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Wearable devices, smart or otherwise, are becoming more prevalent in a variety of markets and industries. The devices may be used in many operations, such as but not limited to identifying a user, storage and transmission of user credentials, storage and transmission of financial information, general user-data storage, user biometric monitoring, and the like. In particular, wearable devices may be used to share user credentials and to perform financial transactions. Most wearable devices communicate data through wireless Wi-Fi, near field communication (NFC), radio frequency identification (RFID), long-term evolution (LTE), and other wireless technologies. Individual identification in consumer based industries may be led by the integration of wearable technology with authentication and identification in both physical and virtual environments. Examples of potential wearable devices that could be included in this integration are smart watches, bands, ear-pods, jewelry, eyeglasses, contact lenses, clothing, and the like. In some circumstances, a wearable device is an entire item (e.g., a smart watch). In other circumstances, a wearable device is a component, chip, section, or other element of a piece of clothing, jewelry, or the like. In such embodiments, the component wearable device may be attached to or embedded within some other article and may be removable, exchangeable, and the like.

A typical financial transaction executed by a user may require the user to present a payment vehicle (e.g., credit card, debit card, scannable token on a wearable device, or the like) to the merchant to complete the transaction. During the process of executing the transaction, the merchant may require the user to provide additional authentication credentials to confirm the identity of the user. This may be in the form of a valid identification document, a signature, a PIN, or the like. Although this form of identification confirmation during the process of executing the transaction may provide a sense of trustworthiness to the merchant, it may result in unnecessary inconvenience to the user. With users performing a multitude of transactions using wearable devices in the financial industry, there is a need to ensure security and convenience. Although wearable devices may be used as a form of a payment vehicle at contactless point-of-sale terminals at merchant locations, the merchant may still have to confirm the identity of the user donning the wearable device at every interaction to determine the trustworthiness of the user and reduce the likelihood of misrepresentation.

The present invention allows a user to submit an authentication request from a wearable device (e.g., automatically or manually based on a user action) to initiate a transaction using the wearable device. The authentication request includes at least one account that the user wants to use via the wearable device for the transaction. The wearable device may then be monitored by an authentication processing system to determine user data, such as using biometric feedback received using physiologic tracking technology incorporated into the wearable device that can read, record, and store individual biometric traits such as heart rate, blood pressure, gait, or other types of physical activity to determine if the user is in possession of the wearable device. Authentication may also be made by verifying that the user is wearing the wearable device and then monitoring the attached nature of the wearable device (e.g., monitoring a clasp, latch, pressure sensor, or the like). User data and wearable device data may be collectively considered possession data, and such possession data may be any information that at least tends to show that the user is in possession of the wearable device.

If it is determined that the user is in possession of the wearable device, the system authenticates the account indicated in the authentication request to enable the transaction using the wearable device at a point-of-sale terminal of a merchant. After the account has been authenticated, the system may also continuously or periodically monitor biometric feedback from the wearable device to determine if the user remains in possession of the wearable device. If it is determined that the user remains in possession of the wearable device, the system maintains authentication to the account, thereby allowing the user to conduct one or more transactions using the wearable device either without further requesting authentication to the account or with minimal further authentication requests.

Referring now to FIG. 1, a block diagram of a system environment 100 is provided, which includes an authentication processing system 110 owned or administrated by an entity, a wearable device 120 associated with a user 140, a mobile device 130 of the user 140, and a network 150. The authentication processing system 110, the wearable device 120 and the mobile device 130 communicate with one another through the network 150, for example by sending electrical singles to each other over the network 150 to perform the actions discussed within this specification and illustrated in the figures. Other devices, systems, servers, or the like may also be included in the system environment 100, such as but not limited to entity systems, such as financial institution systems, which maintain the accounts of the user 140, and third party systems, which may facilitate the transactions of the user 140 by providing hardware and/or applications, or may be merchant systems that receive the requests for the transactions directly from the user 140 or from the entity systems.

A “system environment,” as used herein, may refer to any information technology platform of an enterprise (e.g., a national or multi-national corporation) and may include a multitude of servers, machines, mainframes, personal computers, network devices, front and back end systems, database systems and/or the like.

An “entity,” as used herein, may refer to any business, or person working in the interest of the entity, that has authorization to act on behalf of customers with regard to customers' finance management and/or related operation. For example, an entity may be a financial institute, a mortgage company, a financial consulting firm, a commercial bank, an investment company, or the like. As used herein, the terms “customer” and “user” are interchangeable, both referring to a person who is affiliated with an entity herein defined.

As shown in FIG. 1, the authentication processing system 110 includes a communication interface 112, at least one processor 114, and a memory 116. The memory 116 contains a software module 117, such as computer readable instructions including one or more wearable applications 118 and a database 119. The communication interface 112 may encompass a device that includes hardware, and, in some instances, software, that enables the authentication processing system 110, to transport, send, receive, and/or otherwise communicate information to and/or from the communication interfaces (122, 132, or the like) of one or more other systems on the network 150. For example, the communication interface may include a wireless transceiver, modem, server, electrical connection, and/or other electronic device that operatively connects the authentication processing system 110 to another system, over the network 150. The communication interface may further include an interface that accepts one or more network interface cards, ports for connection of network devices, Universal Serial Bus (USB) connectors and the like. In some embodiments, the authentication processing system 110 may also include a proximity system (not shown), which may include a global positioning system (GPS), NFC, RFID, Bluetooth, or the like.

The processor 114 is operatively coupled to the memory 116 and configured to execute the computer readable code 117. The processor 114 may include a digital signal processor device, a microprocessor device, analog-to-digital converters, digital-to-analog converters, and other support circuits. Control and signal processing functions of the processor 114 may be allocated between these devices according to their respective capabilities. The processor 114 may also include functionality to operate other software programs based on computer executable code thereof, which may be stored, along with the wearable applications 118, on the authentication processing system 110.

The memory 116 may include volatile memory, such as RAM having a cache area for the temporary storage of information. The memory 116 may also include non-volatile memory that may be embedded and/or removable. The non-volatile memory may additionally or alternatively include an Electrically Erasable Programmable Read-Only Memory (EEPROM), flash memory, and/or the like. The memory may store any one or more of pieces of information and data used by the system in which it resides to implement the functions of that system. The memory 116 may include the wearable applications 118 that are utilized to monitor, track, and send and receive, information related to the wearable device 120 as described throughout. The wearable application 118 may communicate with, or have portions of itself located in the other devices, systems, servers, or the like within the system environment.

The database 119 may archive device information (e.g., captured through the wearable applications 118, or the like) associated with wearable and/or mobile devices previously registered with the system 110 and user data including biometric information of customers affiliated with the entity. The database 119 may also store data/results related to and/or used by the wearable applications 118. The applications 118 may perform one or more of the steps and/or sub-steps discussed herein and/or one or more steps not discussed herein.

It will be understood that the authentication processing system 110 may be configured to implement one or more of the various user interfaces and/or process flow described herein. It will also be understood that, in some embodiments, the memory 116 includes other applications. It will also be understood that, in some embodiments, the authentication processing system 110 may be configured to communicate with other entity systems or third-party systems (e.g., for purpose of capturing, identifying, or storing financial information, identification information, or the like of the user 140). The third-party systems may be systems that facilitate the authentication or may be the merchant systems at which the user 140 is requesting to enter into a transaction.

In the embodiment shown in FIG. 1, the wearable device 120 includes a communication interface 122, a processor 124 and a memory 126. The communication interface 122, the processor 124, and the memory 126 are similar to the devices discussed with respect to the authentication processing system 110. However, the memory 126 includes computer readable instructions 127 having one or more applications 128 built therein, and a database 129. In many cases, the wearable device 120 includes one or more sensors configured to gather the physiological and/or movement data of the user 140, such as heart rate, blood pressure, fingerprints, wrist analysis, finger vein, wrist vein, and palm vein patterns, physiological vital signs, temperature, body movements, gait, fluid, skin, breath, or other analysis, or other types of physical activates, contact with the user 140, and the like. The one or more applications 128 may further comprise at least a portion of the wearable applications 118 from the authentication processing system 110. In some cases, the wearable device 120 may include one or more sensors configured to gather information about the wearable device 120, such as whether the wearable device 120 is locked, assembled, or connected, whether the wearable device 120 is secured to the user 140, geographical location of the wearable device 120, the presence of other nearby wearable devices, and the like. The wearable device 120 may, by way of example, include a watch, a wristband, an ear-pod, a necklace, a wristlet, an earring, a headband, a ring, a belt, eyeglasses, contact lenses, clothing, or the like, or a component of the like.

The mobile device 130, as shown in FIG. 1, includes a communication interface 132, a processor 134, positioning device 135, and a memory 136. The communication interface 132, the processor 134, and the memory 136 are similar to the devices discussed with respect to the authentication processing system 110. The memory 136 includes computer readable code 137 having one or more applications 138 built therein (e.g., one or more online banking applications, at least a portion of the wearable applications 118, or other applications) and a database 139. The mobile device 130 may, by way of example, include a smartphone, a personal digital assistant, a personal computer, an electronic notebook, or the like. The one or more applications 138 may also include one or more wearable applications for pairing the mobile device 130 with the wearable device 120.

In some embodiments, the positioning device 135 may be any type of location determining device. In one embodiment the positioning device 135 may include a GPS transceiver. In other embodiments, the positioning device 135 is at least partially made up of an antenna, a transmitter and a receiver. Alternatively, the positioning device 135 may include a NFC interface having one or more proximity sensors embedded therein, such as a RFID tag. Alternatively, the positioning device 135 may be a Bluetooth device. In other embodiments, the positioning device 135 may be devices for allowing Wi-Fi triangulation. The positioning device 135 is specifically described as being part of the mobile device 130, it should be understood that a positioning device may also be included in the wearable device 120.

In some embodiments, the wearable device 120 may be paired with the mobile device 130 via a secure channel between the two unassociated devices over a short range wireless communication channel or other like communication link, providing a secure communicable link between the wearable device 120 and the mobile device 130. The secure channel can be established by utilizing the system application directives, such as by the wearable applications 118, other entity applications, or through third-party web-based applications. Such a secure channel enables the wearable device 120 and mobile device 130 to achieve an extra level of maintained authorization because their connection is protected.

The entity systems (not illustrated) may include the account information that the user is utilizing to enter into a transaction. Alternatively, the third-party systems (not illustrated) may include applications that allow the user to enter into a transaction, or they may be the merchant systems that receive a request from the user to enter into a transaction, and in response communicate with the entity systems. The entity systems and the third-party systems may have communication devices, processors, memory, databases, and applications, as was described with respect to the authentication processing system.

The authentication processing system 110, the wearable device 120 and the mobile device 130 are each operatively connected to the network 150 and in communication with one another, as well as in communication with other devices, systems, servers, or the like, such as the entity systems or third-party systems. The network 150 may include various networking interfaces, such as a LAN, a WAN, a global area network (GAN) (e.g., the Internet), other types of networks, or a hybrid thereof.

The user 140 may utilize the devices in the system environment to enter into, and authenticate, transactions. In some embodiments the user may utilize the mobile device 130 and/or the wearable device to enter into the transactions. In some embodiments, the authentication processing system system 110 may receive an authentication request from the wearable device 120 of the user 140 to initiate a transaction using the wearable device 120. Alternatively, the authentication request may be sent by the user 140 from the mobile device 130 that is securely paired with the wearable device 120, and in such cases, the authentication processing system 110 may communicate directly with the mobile device 130 to retrieve the authentication request transmitted therefrom.

The authentication request may include a transaction type, a transaction amount, and at least one account to be used through the wearable device 120 and/or the mobile device 130 for the transaction. In some embodiments, the authentication request may further include requests for other transactions, such as receiving statements related to an account history, executing a purchase at a point-of-sale of a merchant, processing automated teller machine (ATM) transactions, transferring funds between domestic or international accounts, processing commercial payments related to online bill-pay, peer-to-peer payments, account withdrawals, account deposits, or any combination thereof.

The account, indicated in the request, may be a deposit account, a debit account, a savings account, a checking account, an investment account, a money market account, or a credit account. The authentication request may also include account information associated with the account, such as a username, a password, a PIN, an account number, a card number, one or more related accounts, or any combination thereof. In some embodiments, the authentication request may additionally include device information associated with the wearable device 120 and/or the mobile device 130, which may be any information sufficient to generate a device “fingerprint”, or a unique signature of the user's wearable device 120 and/or the mobile device 130.

The authentication processing system 110, after receiving the authentication request from the user 140, determines whether or not the user 140 is in possession of the wearable device 120, based on the user data including the physiological data sent from the wearable device 120. In some embodiments, the user data is transmitted from the wearable device 120, while in other embodiments, the user data may be transmitted from the mobile device 130. The authentication processing system 110 determines whether or not the user 140 is in possession of the wearable device 120 by comparing the received user data with stored data associated with the user 140 in the database 119 to verify the identity of the user 140. In some embodiments, the authentication processing system 110 verifies the identity of the user 140 by associating the device information, included in the authentication request, with the wearable device 120 previously registered with the system 110.

In some embodiments, the authentication processing system 110 determines the location of the mobile device 130 and/or the wearable device 120 using a positioning device in one or more of the devices. In some embodiments, the authentication processing system 110 determines the location of the mobile device 130 using a proximity system, which is embedded in the system 110 and configured to use proximity sensors located at various locations throughout the world to detect the presence of the one or more proximity sensors associated with the positioning device 135 of the mobile device 130 (or in other embodiments the positioning device of the wearable device 120). In some embodiments, triangulation of cellular signals transmitted from the mobile device 130 (or in other embodiments the positioning device of the wearable device 120), via a GPS transceiver, Wi-Fi triangulation, Bluetooth, or other like device may be used to identify the location of the mobile device 130.

In some embodiments, the location of the wearable device 120 may determine through the mobile device 130 based on the positioning device 135 in the mobile device and a determination that the mobile device 130 is linked with the wearable device 120 (e.g., may require the devices to be a within a particular distance from each other.). For example, the authentication processing system 110 may determine if the user 140 is in possession of the wearable device 120 by determining the location of the mobile device 130, via the positioning device 135 thereon; determining, via the secure channel, that the mobile device 130 is paired with the wearable device 120; and determining that the user 140 is in possession of the wearable device 120, in response to the determination of the location of the mobile device 130 and that the mobile device 130 is paired with the wearable device 120.

In addition to, or alternative to, determining the user data, the system may determine wearable device information related to whether the wearable device 120 is being utilized by the user, such as being connected (e.g., watch clasp together, band connected, or the like), moving, latched, locked data, orientation data, or the like.

If it is determined that the user 140 is in possession of the wearable device 120 (e.g., based on the user data and/or the wearable device data), the system 110 authenticates the account that the user 140 wants to use with the wearable device 120 for the transaction, thereby enabling the execution of the transaction. The execution of the transaction may be done by scanning the wearable device 120 at a point-of-sale terminal of a merchant.

After the account was authenticated, the system 110 continuously monitors user data from the wearable device 120 to determine if the user 140 remains in possession of the wearable device 120. Again, this may be done by comparing the received user data with stored data associated with the user 140 in the database 119 and, additionally, by matching the device information with the wearable device 120 previously registered with the system 110. If it is determined that the user 140 remains in possession of the wearable device 120, the authentication processing system 110 maintains authentication to the account, thereby allowing the user 140 to conduct one or more transactions without further requesting authentication to the same account.

In some embodiments, the system 110 may continuously monitor the wearable device 120 to determine if the user 140 is in possession of the wearable device 120 by continuously monitoring, via the positioning device 135, the location of the mobile device 130; continuously monitoring, via the secure channel, that the mobile device 130 remains paired with the wearable device 120; and determining that the user 140 remains in possession of the wearable device 120, in response to the determination of the location of the mobile device 130 and that the mobile device 130 remains paired with the wearable device 120.

In some embodiments, the authentication may be maintained for a time interval set by the authentication processing system 110, counting from the time once the account was authenticated. In other embodiments, the authentication may be maintained as long as the user 140 wishes until closed by the user 140 (e.g., by disconnecting the wearable device 120 from the authentication processing system 110, by closing the web browser through which the user 140 communicates with the system 110, turning off the wearable device 120, disconnecting the link between the wearable device 120 and the mobile device 130, changing the selection to maintain the connection through an application accessed through the mobile device 130, taking the wearable device off 120, uncoupling the connection of the wearable device, such as unbuckling the strap, or the like).

In some embodiments, the wearable device 120 and/or the mobile device 130 may have displays that include a graphic user interface (GUI), which enables communication between the systems through direct manipulation of graphical elements on the GUI. The graphic elements include, but are not limited to, checkboxes, buttons, radio buttons, dropdown lists, list boxes, text fields, menu bars, and the like. In some embodiments, the confirmation interface may be an electronic communication interface, which can accommodate one or more input and/or output devices, such as display screens and/or speakers, microphones, keys, dials, touchscreens, scanners, cameras, and/or the like. In certain embodiments, the interface may be a web-based interface which enables the systems to communicate with a server through a web browser.

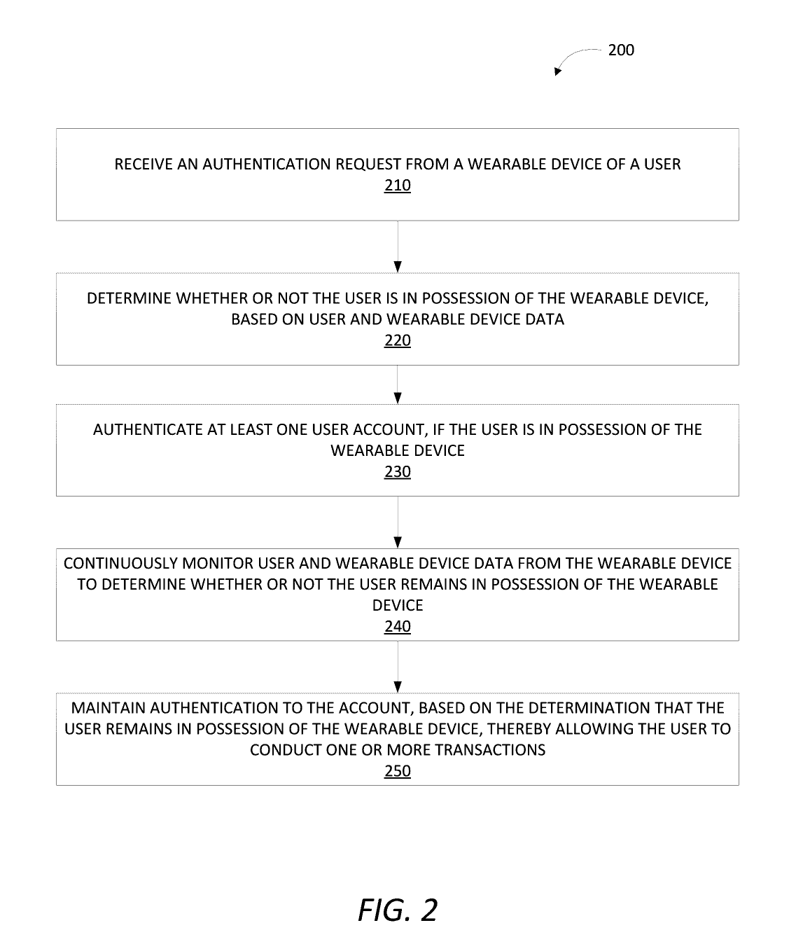

FIG. 2 illustrates a general process flow 200 for using wearable presence to maintain account authentication. The process 200 can be executed by the authentication processing system 110 in the system environment 100, as shown in and described with respect to FIG. 1.

The process 200 includes multiple components, which may all be performed via one or more processors controlled by an authentication processing system owned by an entity. The process 200 starts with block 210 to receive an authentication request from a wearable device 120 of a user 140 affiliated with the entity. As described above, the wearable device includes sensors configured to gather user data (e.g., physiological data, biometric data, user contact data, and the like) and wearable device data (e.g., location data, latched or locked data, orientation data, and the like).

The authentication request in block 210 may include a transaction type, a transaction amount, and at least one account to be used through the wearable device for the transaction when the user 140 is entering a transaction with a merchant. The authentication request may also include device information associated with the wearable device and account information associated with the account that the user wants to use for the transaction. In some embodiments, the authentication request is made prior to any transactions, and may be associated with the wearable device, a mobile device, a webpage, or other communication mechanism between the user and the entity.

In some embodiments, the authentication request may further include requests for transactions related to receiving statements related to an account history, executing a purchase at a point-of-sale of a merchant, processing automated teller machine (ATM) transactions, transferring funds from domestic or international accounts, processing commercial payments related to online bill-pay, peer-to-peer payments, account withdrawals, account deposits, or any combination thereof.

Upon receipt of the authentication request, the process 200 progresses to block 220 to determine whether or not the user is in possession of the wearable device 120 based on data associated with the user 140 and/or the wearable device 120. As described above, this data is gathered by the wearable device 120 and/or a mobile device 130 associated with the user 140 and provides physiological, biometric, user contact, and other user data as well as location, orientation, and other wearable device data, as previously described with respect to FIG. 1. The user data may be transmitted to a mobile device 130 of the user 140 or to an online storage site, both assessable to the authentication processing system. In some embodiments, the authentication processing system determines if the user 140 is in possession of the wearable device by comparing the received user data with stored data associated with the user 140 and by matching the device information associated with the wearable device 120 registered in the system.

For example, a smart watch wearable device or wearable band may alert the system that the wearable device is secured to a body part by sending information about the smart watch or band being latched, sensing heat of a person, sensing pressure of a person, sensing heart rate of a person, or other like user data or wearable device data that can be monitored and captured from the user 140 and/or wearable device 120. In some embodiments, the monitoring of the wearable device by the authentication processing system 110 or other system may occur in intervals, or in real or near-time. This information may provide for the authentication itself or may require further action by the user 140. For example, in one embodiment the user 140 need not take other action as the authentication occurs automatically. In other embodiments, the user 140 may be required to take additional actions once the determination is made that the wearable device is on or with the user 140. For example, the user 140 associated with the smart watch or band may be prompted to provide a response to a notification of authentication, such as a fingerprint to a fingerprint sensor on the smart watch or band. In this example, this fingerprint will be checked against a record of the user's fingerprint(s) to determine whether the fingerprint is actually the expected user's fingerprint. Once the fingerprint is verified, and the wearable device maintains a status of being secured to the user, the system can fairly confidently determine that the user is in possession of the wearable device.

In another example, the system can prompt the user 140 to input a personal identification code and assert that the user 140 is in possession of the wearable device 120. In another example, the system can determine that the wearable device 120 is in close proximity to a mobile device 130 of the user, and therefore likely in possession of the user 140. In some embodiments, the system uses several indicators to determine that the user is in possession of the wearable device 120. For example, the system may use any combination of assertions by the user (before or after a verification process of the user), sensors from the wearable device 120, location data, and/or the like to determine that the user 140 is in possession of the wearable device 120.

In some embodiments, the user 140 may be able to decide what authentication that the user 140 would like to use for different types of transactions. For example, for transactions under “X” amount the user 140 may select to automatically allow the transaction when the wearable device 120 is determined to be with the user 140. Alternatively, the user 140 may select to require verification (e.g., agreement, fingerprint indication, particular number of taps, physical movement of the user, touch actions on a display, or the like) for transactions over “X” amount even when the wearable device 120 is determined to be with the user 140. Moreover, the user 140 may select the type and level of authentication (e.g., multiple levels of authentication). For example, the user 140 may request that transactions are approved when the wearable device 120 is found to be with the user 140. Alternatively, the user 140 may require that not only does the wearable device 120 need to be found to be with the user 140 or the user's mobile device 130, but must also identify a physiological reading of the user 140 that meets a stored physiological reading or receive a specific verification from the user 140. As such, even if the wearable device 120 and the mobile device 130 are compromised, the person that compromised the devices does not know how to provide the specific types of authentication.

Upon determination that the user 140 is in possession of the wearable device 120, the process 200 advances to block 230 to authenticate the at least one account, indicated in the authentication request, for the transaction using the wearable device 120. In some embodiments, this authentication process is the same as an authentication process at a point-of-sale terminal, ATM, or the like. Therefore, if the user 140 purchases a product or service using an account (after the system has determined that the user is in possession of the wearable device), and verifies this account at a point-of-sale terminal, then the system has authenticated the account. As previously discussed, the authentication may be made after it is determined that the user 140 is in possession of the wearable device 120; however, in some embodiments the authentication may require further verification by the user 140.

In other embodiments, the system authenticates at least one account before any transactions are made. For example, the system may ask for a PIN number associated with a debit account, a signature associated with a credit account, a fingerprint associated with an account, a facial scan associated with an account, a voice command associated with an account, and the like. The system may receive a user's authorization input through a user interface (including sensors, buttons, touchscreens, or the like) of a mobile device 130 associated with the user 140, through a user interface (including sensors, buttons, touchscreens, or the like) of the wearable device (especially when the wearable device includes payment account functionality), a website, an ATM user interface, a point-of-sale terminal user interface, or the like. In some embodiments, the account authorization is part of a payment process for the user 140, and therefore the authorization of the account may be used to authorize the account for the current payment.

In some embodiments, block 230 further includes creating a first timestamp when the wearable device is authenticated. This first timestamp can be saved to a database associated with the entity, and may be maintained as for later reference by the system. As discussed in further detail later, the timestamp may be utilized to keep the wearable device 120 and/or the mobile device 130 authenticated for an authentication period of time.

The process 200 may then move to block 240, where the system continuously monitors user data and/or wearable device data from the wearable device 120 to determine whether or not the user 140 remains in possession of the wearable device 120. In such embodiments, the authentication processing system, again, compares the received user data and wearable device data with stored data associated with the user 140 to verify the identity of the user 140 and matches the received device information associated with the wearable device 120 registered in the system (e.g., in the authentication processing system 110). The monitoring may occur at specific time intervals (e.g., every 15, 30, 60 minutes, or the like), or the monitoring may occur in real-time, or near real-time, by continuously sending and receiving electrical singles between the wearable device 120, mobile device 130, the authentication processing system 110, and/or the other devices, systems, or servers described herein.

In embodiments where the account is associated with a payment vehicle that is not the wearable device 120, the system may also continuously monitor the location of the payment vehicle, in relation to the wearable device 120, to determine whether the payment vehicle has also remained in the possession of the user. For example, a user may have an account on a mobile device 130 associated with the user 140. After the system verifies that a wearable device 120 is possessed by the user 140, and after the system authorizes the account of the user 140, the system may then continuously monitor whether the wearable device 120 is still in possession with the user 140 and whether or not the mobile device 130 is within a distance from the wearable device 120 that continuous possession can be assumed (e.g., within 1 ft., 3 ft., 5 ft., 10 ft. 20 ft. 30 ft. 50 ft., or the like). In some embodiments, the fact that the wearable device 120 and the mobile device 130 remain in close proximity is enough to presume that both are also still in possession of the user 140, even without other information regarding the user's possession status of the wearable device 120. Of course, in embodiments where the wearable device 120 is also the payment vehicle, the system only needs to monitor the user's possession status of the wearable device 120.

Upon determination of that the user 140 remains in possession of the wearable device 120 (and in some circumstances, the payment vehicle), the process 200 moves forward to block 250 to maintain authentication to the account such that the user can conduct one or more transactions without further requesting authentication to the account. The system can maintain authorization of the account because the possessive nature of the wearable device 120 creates a very strong presumption that the user 140 associated with the account is in possession of the payment vehicle associated with the account. By maintaining authentication of the account, at least through the payment vehicle, the entity may allow the user 140 to use the account at a point-of-sale terminal, ATM, website, and the like, for a period of time without the normal verification process at each location in which the user uses the account. For example, once a wearable device 120 is determined to be in the possession of the user 140, and once an account associated with the user 140 is authenticated, the user 140 may use the account at multiple locations, for multiple purposes, without having to sign receipts, enter a PIN code, or take other authentication steps.

In some embodiments, the entity may determine that the authentication method of the process 200, and/or the steps used to determine that the user 140 is in possession of the wearable device 120 do not create as strong of a presumption of accuracy as other methods. In such embodiments, the system may provide for reduced authorization by the user over the time period in which the system determines that the user remains in possession of the wearable device 120. For example, the system may only require the user 140 to provide a signature at a point-of-sale terminal instead of the normal authentication process (without the wearable device aspects) of a signature and a security question.

In some embodiments, the authentication is maintained for a predetermined authentication time period set by the authentication processing system (or through the system by the user 140 or entity), counting from the first time stamp (when the account was first authenticated). In such embodiments, the system may prompt the user 140 to renew the authorization of the account at a time period before, at, or right after the predetermined time period ends. Therefore, it is possible for the system to renew authentication for a second predefined authentication time period. In other embodiments, the authentication is maintained until closed by the user (e.g., by disconnecting the wearable device from the authentication processing system, closing the web browser through which the wearable device communicates with the system, turning off the wearable device 120, disconnecting the link between the wearable device 120 and the mobile device 130, changing the selection to maintain the connection through an application accessed through the mobile device 130, taking the wearable device off 120, uncoupling the connection of the wearable device, such as unbuckling the strap, or the like).

It should be noted that when the predetermined time period runs up, or when the system determines that the wearable device 120 is no longer in possession of the user 140, the user 140 may still be able to use the account. However, the user 140 will need to undergo the normal authentication requirements at each transaction and will not receive the benefit of reduced or no further authorization, as afforded by the wearable device 120 and the process 200.

Like the user's ability to set up the authentication described with respect to block 220, the user may also set the authentication time period for which authentication may be maintained. For example, for some types of transactions authentication may be maintained indefinitely (e.g., until the user turns off authentication) when the cost of the transaction is less than “X” amount. Alternatively, if a transaction is greater than “X” amount and less than “Y” amount the authentication may only last for one day, while for transactions greater than “Y” amount authentication may not be maintained. Moreover, the user 140 may also determine what turns off the authentication. For example, by disconnecting the wearable device from the authentication processing system, closing the web browser through which the wearable device communicates with the system, turning off the wearable device 120, disconnecting the link between the wearable device 120 and the mobile device 130, and changing the selection to maintain the connection through an application accessed through the mobile device 130 may stop authentication. However, taking the wearable device off 120 and/or uncoupling the connection of the wearable device, such as unbuckling the strap, for less than one minute would not stop authentication. It should be noted that these examples of the user setting the authentication time periods and amounts are only examples, and the user 140 may set any type of restriction or allowance whether or not discussed herein.

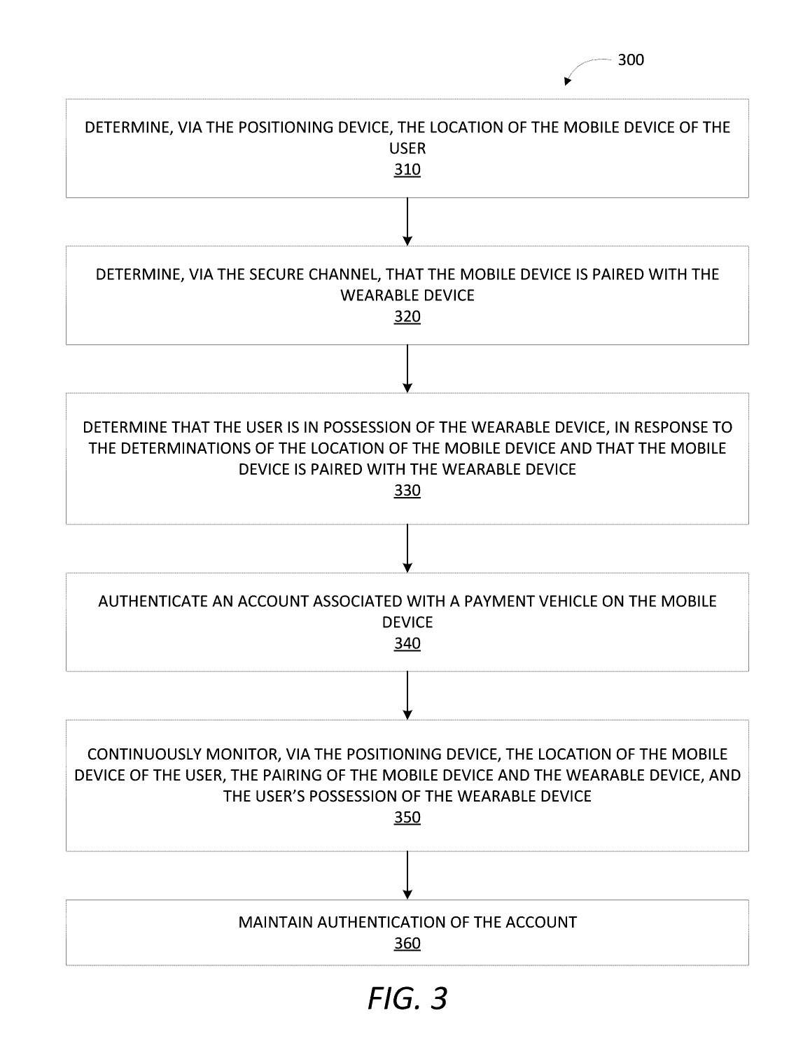

FIG. 3 illustrates a general process flow 300 for determining whether or not the user 140 is in possession of a wearable device 120. At block 310, the process 300 determines the location of a mobile device 130 that is paired with the wearable device 120. In some embodiments, the location of the mobile device 130 is determined via a positioning device 135 installed on the mobile device 130, which may include a NFC interface having one or more proximity sensors, such as a RFID tag. In some embodiments, the location of the mobile device 130 is determined by a proximity system installed on the authentication processing system, which is configured to use proximity sensors located at various locations throughout the world to detect the presence of the one or more proximity sensors associated with the positioning device 135 of the mobile device. In some embodiments, triangulation of cellular signals transmitted (e.g., via a GPS transceiver, Wi-Fi triangulation, Bluetooth device, or other signals) from the mobile device 130 may be used to identify the location of the mobile device 130.

At block 320, the system determines whether or not the mobile device 130 is still paired with the wearable device 120, via a secure channel between the wearable and mobile devices 120, 130 over a short range wireless communication channel (e.g., within a particular distance). The secure channel is established utilizing the system application directives, or through one or more wearable applications downloaded onto the mobile device 130 and/or wearable device 120. The system may determine that the wearable device 120 and the mobile device 130 are paired due to their locations being within a certain geographic distance, either through sensors on the devices or through the system's determined location of both devices (e.g., NFC, RFID, GPS, Bluetooth, or the like).

At block 330, the process 300 determines that the user is in possession of the wearable device, in response to the operations described in block 310 and block 320. In some embodiments, the system makes this determination in the same or a similar manner to the determination in block 220 of FIG. 2.

Additionally, the process 300 may continue to block 340, where the system authenticates an account associated with a payment vehicle on the mobile device. This authentication may be similar to the authentication step in block 230 of FIG. 2.

The process 300 can then continue to block 350, where the system continuously monitors three elements: (1) the location of the mobile device of the user, via the positioning device 135 of the mobile device (and in some embodiments the positioning device in the wearable device 120); (2) the pairing of the mobile device and the wearable device (e.g., in intervals or in real or near-real time); and (3) the user's possession of the wearable device (e.g., by monitoring the user data and/or wearable device data captured by the wearable device). When all three of these elements are satisfied, the process 300 can continue to block 360 where the system maintains authentication of the account, allowing the user 140 to use the payment vehicle with reduced or no further authorization for a predetermined period of time.

However, if at block 350, one of the three elements is not satisfied, the system will remove its authorization of the account. This step may be followed by the system requesting re-authorization, additional authorization, or some other requirement of the user 140 for re-establishing the authentication of the account. Of course, in such circumstances, the user 140 may still be able to use their account, but will need to undergo the full authorization process for each transaction instead of having the reduced or no further authorization as afforded by the wearable device and the process 300.

Although a number of implementations have been described in detail above, other modifications, variations and implementations are possible in light of the foregoing teaching. The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. As used herein, all numbers may be read as if prefaced by the term “about,” even if the term does not expressly appear. Also, any numerical range recited herein is intended to include all sub-ranges subsumed therein. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. Thus, although not expressly described, any or each of the features of the invention disclosed herein may be combined in any manner.

Accordingly, the invention is to be defined not by the preceding illustrative description but instead by the scope of the following claims.

To supplement the present disclosure, this application further incorporates entirely by reference the following commonly assigned patent applications:

| | | | |
|---|---|---|---|
| | U.S. patent | | |
| Docket Number | application Ser. No. | Title | Filed On |

| | | |
|---|---|---|
| 6805US1.014033.2500 | USE OF WEARABLE | Concurrently |
| | AS AN ACCOUNT | Herewith |
| | CONTROL SYSTEM | |
| 6806US1.014033.2501 | A SYSTEM FOR | Concurrently |
| | AUTHENTICATING A | Herewith |
| | WEARABLE DEVICE | |
| | FOR TRANSACTION | |
| | QUEUING | |
| 6809US1.014033.2506 | A SYSTEM FOR | Concurrently |
| | AUTHENTICATING | Herewith |
| | THE USE OF A | |
| | WEARABLE DEVICE | |
| | TO EXECUTE A | |
| | TRANSACTION | |
| 6834US1.014033.2507 | A SYSTEM FOR | Concurrently |
| | AUTHENTICATING A | Herewith |
| | MOBILE DEVICE FOR | |
| | COMPREHENSIVE | |
| | ACCESS TO A | |
| | FACILITY | |

What is claimed is:

1. A system for using wearable presence to maintain account authentication, the system comprising:
a computer apparatus comprising at least one processor and a memory; and
a software module, stored in the memory, comprising computer readable code executable by the processor to cause the processor to:
receive an authentication request from a wearable device of a user, wherein the wearable device comprises one or more sensors configured to gather user data comprising physiological data, movement data, or a combination of both;
determine that the user is in possession of the wearable device, based on the user data;
authenticate the at least one account, if the user is in possession of the wearable device, to enable execution of one or more transactions via the wearable device;
monitor the user data from the wearable device to determine that the user remains in possession of the wearable device; and
maintain authentication to the account, based on the determination that the user remains in possession of the wearable device, thereby allowing the user to conduct the one or more transactions upon authentication.

2. The system of claim 1, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

3. The system of claim 2, wherein the user data is transmitted to the mobile device or to an online storage site, both accessible to the system.

4. The system of claim 2, wherein the authentication request is sent through the mobile device.

5. The system of claim 2, wherein the software module is further configured to:
determine, via the positioning device, the location of the mobile device of the user;
determine, via the secure channel, that the mobile device is paired with the wearable device; and
determine that the user is in possession of the wearable device, in response to determination of the location of the mobile device and that the mobile device is paired with the wearable device.

6. The system of claim 2, wherein the software module is further configured to:
monitor the mobile device, via the positioning device, to determine the location of the mobile device of the user;
monitor the mobile device, via the secure channel, to determine that the mobile device remains paired with the wearable device; and
monitor that the user remains in possession of the wearable device, in response to the determination of the location of the mobile device and that the mobile device remains paired with the wearable device.

7. The system of claim 1, wherein the authentication request comprises the user account information comprising a username, a password, a personal identification number (PIN), an account number, a card number, one or more related accounts, or any combination thereof.

8. The system of claim 1, wherein the physiological data comprises heart rate, blood pressure, fingerprints, finger, vein, wrist, or palm vein or skin patterns, temperature, skin reading, fluid reading, or breath reading; wherein the movement data comprises body movements or gait.

9. The system of claim 1, wherein the authentication request comprises requests for receiving statements related to an account history, executing a purchase at a point-of-sale of a merchant, processing automated teller machine (ATM) transactions, transferring funds from domestic or international accounts, processing commercial payments related to online bill-pay, peer-to-peer payments, account withdrawals, account deposits, or any combination thereof, and the authentication requests comprises a transaction type, a transaction amount, or at least one account to be used via the wearable device for the transaction.

10. The system of claim 1, wherein the wearable device comprises a watch, a wristband, an ear-pod, a necklace, a wristlet, an anklet, an earring, a headband, a ring, a belt, eyeglasses, contact lenses, or clothing.

11. The system of claim 1, wherein the at least one account comprises a deposit account, a debit account, a savings account, a checking account, an investment account, a money market account, or a credit account.

12. The system of claim 1, wherein the authentication is maintained until closed by the user.

13. The system of claim 1, wherein the authentication is maintained for a time period set by an entity maintaining the account for the user.

14. A computer-implemented method for using wearable presence to maintain account authentication, the method comprising:
receiving an authentication request from a wearable device of a user, wherein the wearable device comprises one or more sensors configured to gather user data comprising physiological data, movement data, or a combination of both;
determining that the user is in possession of the wearable device, based on the user data;
authenticating the at least one account, if the user is in possession of the wearable device, to enable execution of one or more transactions via the wearable device;
monitoring the user data from the wearable device to determine that the user remains in possession of the wearable device; and
maintaining authentication to the account, based on the determination that the user remains in possession of the wearable device, thereby allowing the user to conduct the one or more transactions upon authentication.

15. The method of claim 14, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

16. The method of claim 15, wherein determining further comprises:
determining, via the positioning device, the location of the mobile device of the user;
determining, via the secure channel, that the mobile device is paired with the wearable device; and
determining that the user is in possession of the wearable device, in response to the determination of the location of the mobile device and that the mobile device is paired with the wearable device.

17. The method of claim 15, wherein continuously monitoring further comprises:
monitoring the mobile device, via the positioning device, to determine the location of the mobile device of the user;
monitoring the mobile device, via the secure channel, to determine that the mobile device remains paired with the wearable device; and
monitoring that the user remains in possession of the wearable device, in response to the determination of the location of the mobile device and that the mobile device remains paired with the wearable device.

18. A computer program product for using wearable presence to maintain account authentication, the computer program product comprising a non-transitory computer readable medium having one or more computer-readable programs stored therein, and the computer readable programs, when executed by a computer apparatus, cause the computer apparatus to perform the following steps:
receiving an authentication request from a wearable device of a user, wherein the wearable device comprises one or more sensors configured to gather user data comprising physiological data, movement data, or a combination of both;
determining that the user is in possession of the wearable device, based on the user data;
authenticating the at least one account, if the user is in possession of the wearable device, to enable execution of one or more transactions via the wearable device;
monitoring the user data from the wearable device to determine that the user remains in possession of the wearable device; and
maintaining authentication to the account, based on the determination that the user remains in possession of the wearable device, thereby allowing the user to conduct the one or more transactions upon authentication.

19. The computer program product of claim 18, wherein the wearable device is paired with a mobile device of the user via a secure channel between the two devices over a short range wireless communication channel, wherein the secure channel is established by utilizing one or more applications provided by the system or by third-parties, and wherein the mobile device comprises a positioning device.

20. The computer program product of claim 19, wherein the computer readable programs, when executed, further cause the computer apparatus to:
monitor the mobile device, via the positioning device, to determine the location of the mobile device of the user;
monitor the mobile device, via the secure channel, to determine that the mobile device remains paired with the wearable device; and
monitor that the user remains in possession of the wearable device, in response to the determination of the location of the mobile device and that the mobile device remains paired with the wearable device.
